(19) United States
(12) Patent Application Publication
(10) Pub. No.: US 2022/0408204 A1
(43) Pub. Date: Dec. 22, 2022

(54) ONE PIECE MICROACTUATOR MEMBRANE

(71) Applicant: Earlens Corporation, Menlo Park, CA (US)

(72) Inventors: Kyle Imatani, Mountain View, CA (US); Stuart Wenzel, San Carlos, CA (US); Brian E. Nordby, Sunnyvale, CA (US)

(21) Appl. No.: 17/356,217

(22) Filed: Jun. 23, 2021

Related U.S. Application Data
(60) Provisional application No. 63/213,127, filed on Jun. 21, 2021.

(51) Int. Cl. H04R 25/00

(52) U.S. Cl. CPC H04R 25/606; H04R 25/65

(57) ABSTRACT

An improved microactuator for use in a contact hearing aid, wherein the microactuator includes a one-piece membrane. The one piece membrane being adapted to prevent moisture from entering the microactuator through the microactuator reed opening when the contact hearing aid microactuator is placed in the ear canal of a patient.

### CROSS-REFERENCE

This application claims the benefit of Provisional Application Ser. No. 63/213,127, filed Jun. 21, 2021, which is incorporated herein by reference in its entirety and to which application we claim priority under 35 USC § 120

### FIELD OF THE INVENTION

The present invention is directed to methods and devices for preventing fluid ingress in microactuator for use in contact hearing devices.

### BACKGROUND

In hearing devices, including contact hearing devices which utilize microactuators, including balanced armature microactuators, such as the contact hearing aids available from Earlens Corporation, the microactuator may include one or more ingress membranes intended to prevent fluid from getting into the microactuator (i.e. to prevent fluid ingress). Such ingress membranes may be subject to failure modes, including delamination or tearing, which may result in fluid ingress. In certain circumstances fluid in the microactuator may cause the microactuator to fail or the output of the microactuator to decrease. Delamination of the ingress membrane is most likely to occur at bonding joints and may be caused by swelling of the ingress membrane material or by swelling of the adhesive used to affix the ingress membrane material to the microactuator in the presence of fluids. In contact hearing devices which are placed in the ear canal of a user, the ingress membrane may be exposed to any one of a number of bodily fluids (including cerumen and sweat) and/or fluids introduced into the ear canal by the user or health care professional (including water, alcohol and mineral oil). In such microactuators, the bonding joints may include joints at the interface between the ingress membrane and the body of the microactuator and at the interface between the ingress membrane and the output reed. Potential benefits to improved adhesion at the microactuator-ingress membrane interface and the ingress membrane-reed interface may include more a stable output, a more stable Maximum Effective Power Output (MEPO), reduced sound variability, reduced need for manufacturing remakes and reduced returns for credit.

In some hearing devices delamination of the ingress membrane at an adhesive joint is a mechanism of failure which may result in fluid getting into the interior of the microactuator. In certain circumstances, the ingress membrane material may swell, causing the adhesive joints to break. In certain circumstances a 20% or greater change in the volume of the ingress membrane material may break bonds between the adhesive and the ingress membrane. When fluid gets past the ingress membrane, it can cause the performance of the contact hearing aid to degrade. For example, the degradation in performance may include intermittent output, reduced output and/or reduced MEPO. Alternatively the contact hearing aid may fail entirely and provide no output. In some microactuators, there are two key areas at which an ingress membrane bond can fail, including around the attachment point to the microactuator, which may be a stainless-steel ring, and at the attachment point to the microactuator reed.

In order to improve the performance of contact hearing aids including microactuators which utilize ingress membranes to prevent fluids from entering the microactuator, the adhesion of the microactuator ingress membrane to the microactuator and the microactuator reed may be improved by using the apparatus and methods described herein.

### BRIEF DESCRIPTION OF THE DRAWINGS

The foregoing and other objects, features and advantages of embodiments of the present inventive concepts will be apparent from the more particular description of preferred embodiments, as illustrated in the accompanying drawings in which like reference characters refer to the same or like elements. The drawings are not necessarily to scale, emphasis instead being placed upon illustrating the principles of the preferred embodiments.

FIG. 1 illustrates a microactuator including a one-piece microactuator membrane according to the present invention.

FIG. 2 is a front perspective view of a one-piece microactuator membrane according to the present invention.

FIG. 3 is a side view of a one-piece microactuator membrane according to the present invention.

FIG. 4 is a side cut away view of the distal end of a microactuator with a one-piece microactuator membrane according to the present invention.

FIG. 5 is an alternative side cut away view of the distal end of a microactuator with a one-piece microactuator membrane according to the present invention.

FIG. 6 is an alternative side cut away view of the distal end of a microactuator, including a drive post, with a one-piece microactuator membrane according to the present invention

### DETAILED DESCRIPTION OF THE INVENTION

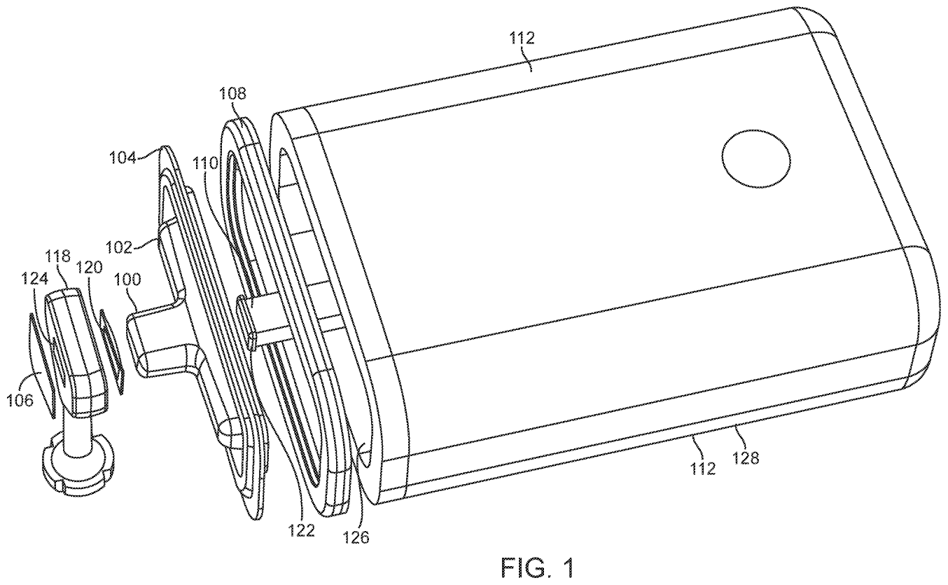

FIG. 1 illustrates a microactuator 112, including a microactuator body 128 and a one-piece membrane 104 according to the present invention. In FIG. 1, microactuator body 128 includes microactuator reed opening 126. One-piece membrane 104 includes reed covering 100 and bellows 102. Reed covering 100 covers microactuator reed 110 when one-piece membrane 104 is attached to microactuator 112. Inner membrane sealant 122 may be used to affix one-piece membrane 104 to microactuator reed 110 at a distal end of microactuator reed 110. One-piece membrane 104 may be held in place on microactuator 112 by membrane skirt sealant 108. Drive post 118 may be mounted on microactuator reed 110 with microactuator reed 110 and reed covering 100 passing through keyhole 124. Keyhole 124 may be held in place on reed covering 100 by keyhole drive post sealant 120 and outer drive post sealant 106, which may be for example a UV-cure epoxy such as, for example, OG116-31 from Epotek.

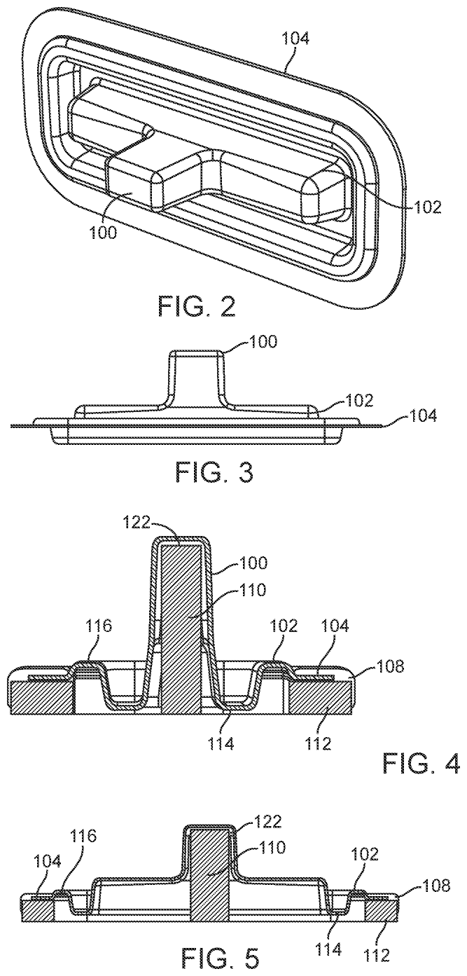

FIG. 2 is a front perspective view of one-piece microactuator membrane 104 according to the present invention. FIG. 3 is a side view of one-piece microactuator membrane 104 according to the present invention. In FIGS. 2 and 3 one-piece microactuator membrane 104 includes reed covering 100 and bellows 102.

FIG. 4 is a side cut away view of the distal end of microactuator 112 including one-piece microactuator membrane 104 according to the present invention. FIG. 5 is an alternative side cut away view of the distal end of a microactuator with a one-piece microactuator membrane according to the present invention. In FIGS. 4 and 5 microactuator 112 includes microactuator reed 110. One-piece microactuator membrane 104 includes bellows 102 and reed covering 100. Bellows 102 includes inner bellows curve 114 and outer bellows curve 116. One-piece microactuator membrane 104 may be held in place on microactuator 112 by membrane skirt sealant 108 and inner membrane sealant 122.

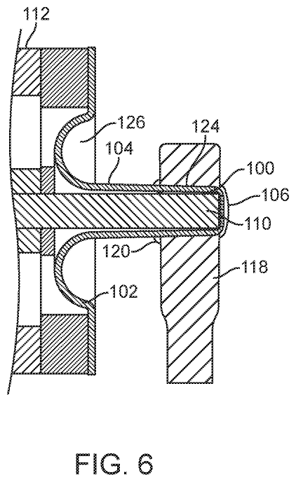

FIG. 6 is an alternative side cut away view of the distal end of microactuator 112, including drive post 118 and one-piece microactuator membrane 104 according to the present invention. In FIG. 6, one-piece microactuator membrane 104 includes reed covering 100 which is positioned over microactuator reed 110. Microactuator reed 110 is held in place on reed covering 100 by outer drive post sealant 106 and keyhole drive post sealant 120, which may be for example a UV-cure epoxy such as, for example, OG116-31 from Epotek.

In embodiments of the invention one-piece membrane, which may also be referred to as a one-piece sock, may: include a large, compliant bellows such as bellows 102; conform to microactuator reed 110; cover the end of microactuator reed 110; be formed of a one-piece design; and include a double lap joint design for strength at the reed.

In embodiments of the invention keyhole drive post sealant 120, which may also be referred to as a drive post adhesive works with outer drive post sealant 106 to affix drive post 118 to reed covering 100 which is affixed to microactuator reed 110 by inner membrane sealant 122, which may be for example a UV-cure epoxy such as, for example, OG116-31 from Epotek. Key hole drive post sealant 120 coats the portion of reed covering 100 in keyhole 124.

In embodiments of the invention a microactuator may include an outer shell, the outer shell including a microactuator reed opening at a distal end thereof. The present invention may further include a microactuator reed extending from an interior of the outer shell though the microactuator reed opening. The present invention may further include an ingress membrane mounting surface connected to the outer shell and surrounding the microactuator reed opening. The present invention may further include an ingress membrane mounting ring adhesive positioned on the ingress membrane mounting surface. The present invention may further include an ingress membrane, the ingress membrane comprising a mounting ring and a central section, wherein the mounting ring surrounds the central section, the mounting ring being positioned on the ingress membrane mounting ring adhesive. The present invention may further include an ingress membrane reed covering in the central portion of the ingress membrane, wherein the microactuator reed extends into but not through the membrane reed covering. The present invention may further include an encapsulation shield, the encapsulation shield extending over the ingress membrane mounting ring. The present invention may further include an inner membrane sealant connecting the ingress membrane to the microactuator reed inside the membrane reed covering at a distal end of the membrane reed covering. The present invention may further include an outer drive post sealant positioned on the distal end of the membrane reed covering and contacting a distal surface of a drive post where the distal end of the membrane reed covering passes through a drive post keyhole. The present invention may further include a keyhole drive post sealant contacting a portion of an outer surface of the membrane reed covering and contacting a proximal surface of the drive post where the membrane reed covering passes through the drive post keyhole. In embodiments of the invention the outer shell is constructed of a ferrous material. In embodiments of the invention an end ring is positioned on the microactuator at a distal end of the outer shell, the end ring comprising stainless steel. In embodiments of the invention the ingress membrane mounting surface at a distal end of the end ring.

In embodiments of the invention a microactuator assembly may include a microactuator, the microactuator including a microactuator body and a microactuator reed. The present invention may further include a one-piece membrane, the one-piece membrane including a reed covering and a bellows. The present invention may further include a membrane skirt sealant positioned between the one-piece membrane and the microactuator, wherein the membrane skirt sealant attaches the one-piece membrane to the microactuator body. The present invention may further be characterized in that the reed covering does not include any openings. The present invention may further include a microactuator assembly wherein the microactuator assembly further includes a drive post, the drive post comprising a keyhole, wherein a distal end of the reed covering and the microactuator reed extend through the keyhole. In embodiments of the present invention a distal end of the microactuator reed is affixed to an interior surface of the distal end of the reed covering by an inner membrane sealant. In embodiments of the present invention the reed covering passes through the keyhole with a distal end of the reed covering extending out of a distal side of the keyhole. In embodiments of the present invention a middle region of the reed covering enters a proximal end of the keyhole. In embodiments of the present invention an outer surface of the distal end of the reed covering is affixed to a distal side of the drive post by an outer drive post sealant. In embodiments of the present invention the outer drive post sealant is an epoxy sealant. In embodiments of the present invention an outer surface of the middle region of the reed covering is affixed to a proximal surface of the drive post by a keyhole drive post sealant. In embodiments of the present invention the keyhole drive post sealant is an epoxy sealant.

While the preferred embodiments of the devices and methods have been described in reference to the environment in which they were developed, they are merely illustrative of the principles of the present inventive concepts. Modification or combinations of the above-described assemblies, other embodiments, configurations, and methods for carrying out the invention, and variations of aspects of the invention that are obvious to those of skill in the art are intended to be within the scope of the claims. In addition, where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claim.

1. A microactuator comprising:
an outer shell, the outer shell including a microactuator reed opening at a distal end thereof;
a microactuator reed extending from an interior of the outer shell though the microactuator reed opening;
an ingress membrane mounting surface connected to the outer shell and surrounding the microactuator reed opening;
an ingress membrane mounting ring adhesive positioned on the ingress membrane mounting surface;
an ingress membrane, the ingress membrane comprising a mounting ring and a central section, wherein the mounting ring surrounds the central section, the mounting ring being positioned on the ingress membrane mounting ring adhesive;
an ingress membrane reed covering in the central portion of the ingress membrane, wherein the microactuator reed extends into but not through the membrane reed covering;
an encapsulation shield, the encapsulation shield extending over the ingress membrane mounting ring;
an inner membrane sealant connecting the ingress membrane to the microactuator reed inside the membrane reed covering at a distal end of the membrane reed covering;
an outer drive post sealant positioned on the distal end of the membrane reed covering and contacting a distal surface of a drive post where the distal end of the membrane reed covering passes through a drive post keyhole; and
a keyhole drive post sealant contacting a portion of an outer surface of the membrane reed covering and contacting a proximal surface of the drive post where the membrane reed covering passes through the drive post keyhole.

2. A microactuator according to claim 1 wherein the outer shell is constructed of a ferrous material.

3. A microactuator according to claim 1 wherein an end ring is positioned on the microactuator at a distal end of the outer shell, the end ring:
comprising stainless steel; and
including the ingress membrane mounting surface at a distal end thereof.

4. A microactuator assembly comprising:
a microactuator, the microactuator comprising a microactuator body and a microactuator reed;
a one-piece membrane, the one-piece membrane comprising a reed covering and a bellows;
a membrane skirt sealant positioned between the one-piece membrane and the microactuator, wherein the membrane skirt sealant attaches the one-piece membrane to the microactuator body; and
wherein the reed covering does not include any openings.

5. A microactuator assembly according to claim 4 wherein the microactuator assembly further includes a drive post, the drive post comprising a keyhole, wherein a distal end of the reed covering and the microactuator reed extend through the keyhole.

6. A microactuator assembly according to claim 5 wherein a distal end of the microactuator reed is affixed to an interior surface of the distal end of the reed covering by an inner membrane sealant.

7. A microactuator assembly according to claim 6 wherein the reed covering passes through the keyhole with a distal end of the reed covering extending out of a distal side of the keyhole.

8. A microactuator according to claim 7 wherein a middle region of the reed covering enters a proximal end of the keyhole.

9. A microactuator according to claim 8 wherein an outer surface of the distal end of the reed covering is affixed to a distal side of the drive post by an outer drive post sealant.

10. A microactuator according to claim 9 wherein the outer drive post sealant is an epoxy sealant.

11. A microactuator according to claim 10 wherein an outer surface of the middle region of the reed covering is affixed to a proximal surface of the drive post by a keyhole drive post sealant.

12. A microactuator according to claim 11 wherein the keyhole drive post sealant is an epoxy sealant.
